(19) United States
(12) Patent Application Publication
(10) Pub. No.: US 2026/0092622 A1
(43) Pub. Date: Apr. 2, 2026

(54) SUCTION CUP ASSEMBLY

(71) Applicant: TILTA INC., Burbank, CA (US)

(72) Inventors: Yiling WANG, Shenzhen (CN); Wenping ZENG, Shenzhen (CN); Kefeng ZHOU, Shenzhen (CN)

(21) Appl. No.: 19/332,578

(22) Filed: Sep. 18, 2025

(30) Foreign Application Priority Data
Sep. 30, 2024 (CN) 2024224293770

(51) Int. Cl. F16B 47/00

(52) U.S. Cl. CPC F16B 47/00

(57) ABSTRACT

A suction cup assembly includes a suction cup, a housing assembly, a connection assembly, and a control assembly. When the control assembly controls the suction cup to adhere to an external surface that has water stains or accumulated water, the control assembly evacuates air from an adsorption cavity of the suction cup, thereby drawing water stains or accumulated water into the connection assembly along with the air. The moisture-laden air is then discharged out of the housing assembly. As a result, the internal components of the suction cup assembly are less affected by environmental conditions and is provided with a moisture-resistant function.

### CROSS-REFERENCE TO RELATED APPLICATIONS

The present application for patent claims priority to and the benefit of pending Chinese Application No. 2024224293770, which is filed on September 30, 2024, and expressly incorporated by reference herein as if fully set forth below in its entirety and for all applicable purposes.

### TECHNICAL FIELD

The present disclosure pertains to the technical field of suction cups, especially to a suction cup assembly.

### INTRODUCTION

In daily life, electric suction cups are capable of adhering to external structures and are therefore widely used in various fields. During use, the user can operate the suction cup to activate it, thereby evacuating air from the suction cup so that it adheres to an external structure. However, conventional electric suction cup designs are susceptible to environmental influences. For example, the operating environment may contain accumulated water, water stains, or similar conditions. When the suction cup begins evacuating air to establish adhesion, water stains or accumulated water may be drawn into the interior of the suction cup assembly, potentially resulting in dampening of internal components, including electronic elements.

### BRIEF SUMMARY

The present disclosure provides a suction cup assembly that addresses the technical problem wherein conventional electric suction cup designs are susceptible to environmental influences. For example, the operating environment may contain accumulated water, water stains, or similar conditions. When the suction cup begins evacuating air to establish adhesion, water stains or accumulated water may be drawn into the interior of the suction cup assembly, potentially resulting in dampening of internal components, including electronic elements.

To resolve the aforementioned technical problem, the following technical solution is provided:

A suction cup assembly including:

a suction cup having an adsorption cavity;

a housing assembly detachably connected to the suction cup and having an opening;

a connection assembly disposed within the housing assembly and in communication with the adsorption cavity; and

a control assembly disposed within the housing assembly and connected to an end of the connection assembly away from the adsorption cavity, the control assembly is provided with a first discharge tube, wherein an open end of the first discharge tube is accommodated within the opening.

This disclosure provides a suction cup assembly. When the control assembly controls the suction cup to adhere to an external structure that has water stains or accumulated water, the control assembly evacuates air from the adsorption cavity of the suction cup, thereby drawing water stains or accumulated water into the connection assembly along with the air. The moisture-laden air is then discharged out of the housing assembly of the suction cup assembly through the first discharge tube via the opening. As a result, the internal structure of the suction cup is less affected by environmental conditions and is provided with a moisture-proof function.

### BRIEF DESCRIPTION OF THE DRAWINGS

FIG. 1 is a diagram illustrating a suction cup assembly according to some aspects of the disclosure.

FIG. 2 is a diagram illustrating a first exploded view of the suction cup assembly according to some aspects of the disclosure.

FIG. 3 is a second exploded view of the suction cup assembly from another perspective according to some aspects of the disclosure.

FIG. 4 is a top view of the suction cup assembly according to some aspects of the disclosure.

FIG. 5 is a diagram illustrating a first discharge tube according to some aspects of the disclosure.

### Legend:

10. suction cup assembly;

1. suction cup; 11. adsorption cavity; 12. air evacuation port;

2. housing assembly; 21. opening; 22. housing; 23. connecting member; 231. connection interface; 232. support arm; 233. receiving cavity; 24. limiting member; 241. limiting space;

3. connection assembly; 31. three-way connector; 311. third port; 312. fourth port; 313. fifth port; 32. connecting tube;

4. control assembly; 41. first discharge tube; 411. open end; 412. first conduit; 413. connector; 414. clamping groove; 415. mounting hole; 42. control pump; 43. pump housing; 431. first port; 432. second port; 44. detection module; 45. check valve;

5. power source;

6. circuit board.

The objectives, functional features, and aspects of this disclosure will be further explained with reference to the embodiments and accompanying drawings.

### DETAILED DESCRIPTION

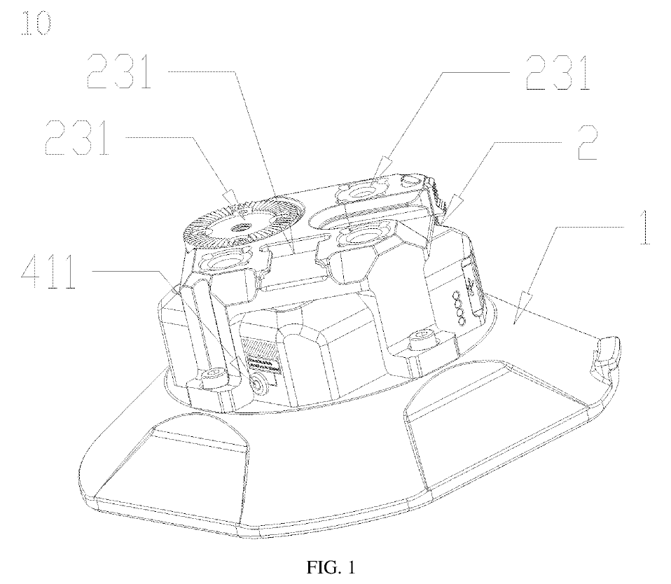

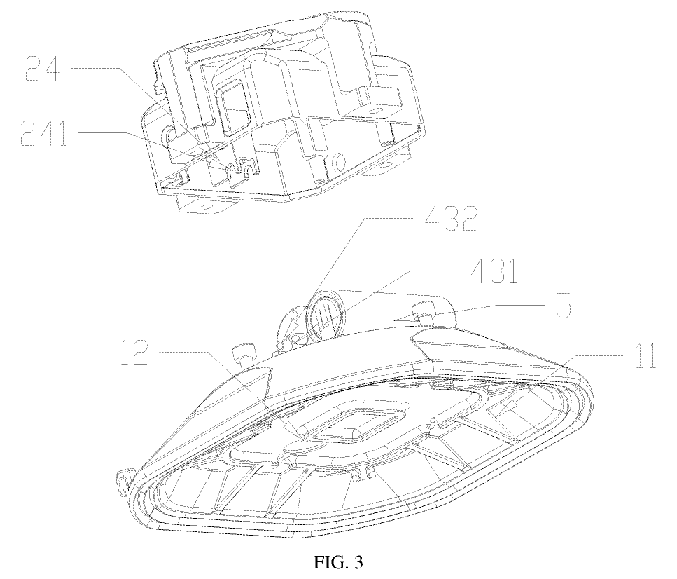

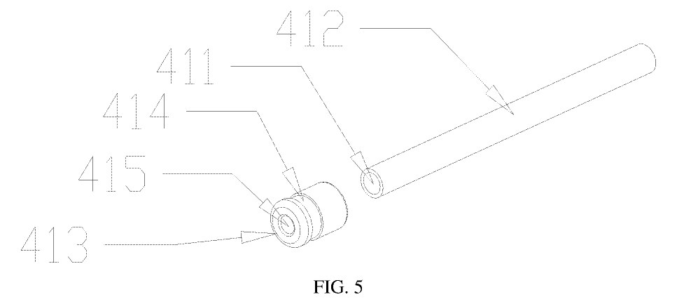

Referring to FIGS. 1-5, the present disclosure provides a suction cup assembly 10, which includes a suction cup 1, a housing assembly 2, a connection assembly 3, and a control assembly 4. The suction cup 1 is provided with an adsorption cavity 11. The housing assembly 2 is detachably connected to the suction cup 1 and includes an opening 21. The connection assembly 3 is disposed within the housing assembly 2 and is in communication with the adsorption cavity 11. The control assembly 4 is disposed within the housing assembly 2 and is connected to an end of the connection assembly 3 distal from the adsorption cavity 11. The control assembly 4 is provided with a first discharge tube 41, and an open end 411 of the first discharge tube 41 is accommodated within the opening 21.

During use, the adsorption surface may contain water stains or accumulated water. When the suction cup 1 adheres to such a surface, activation of the suction cup 1 causes the control assembly 4 to initiate air evacuation. Under the suction effect, the air evacuation port inside the suction cup 1 may draw in mist or moisture, thereby causing electronic components to become damp and reducing the service life of the suction cup 1. In some cases, the user may wipe the adsorption surface to remove water stains or accumulated water. However, in practice, the surface may remain damp after wiping, and the internal structure of the suction cup 1 may still be affected by moisture.

In some aspects, the suction cup 1 may be provided with an air evacuation port 12. Air from the adsorption cavity 11 flows into the connection assembly 3 through the air evacuation port 12.

This disclosure provides a suction cup assembly 10 that includes the first discharge tube 41. The open end 411 of the first discharge tube 41 is exposed on the housing assembly 2. When the control assembly 4 controls the suction cup 1 to adhere to an external structure or surface that has water stains or accumulated water, the control assembly 4 evacuates air from the adsorption cavity 11 of the suction cup 1, thereby drawing moisture into the connection assembly 3 along with the air. The moisture-laden air is then discharged out of the housing assembly 2 of the suction cup assembly 10 through the first discharge tube 41 via the opening 21. Therefore, the internal structure of the suction cup 1 is less affected by environmental influences (e.g., moisture) and is provided with a moisture-proof or moisture-resistant function. In some aspects, this configuration prevents the circuit board 6 inside the suction cup 1 from becoming damp.

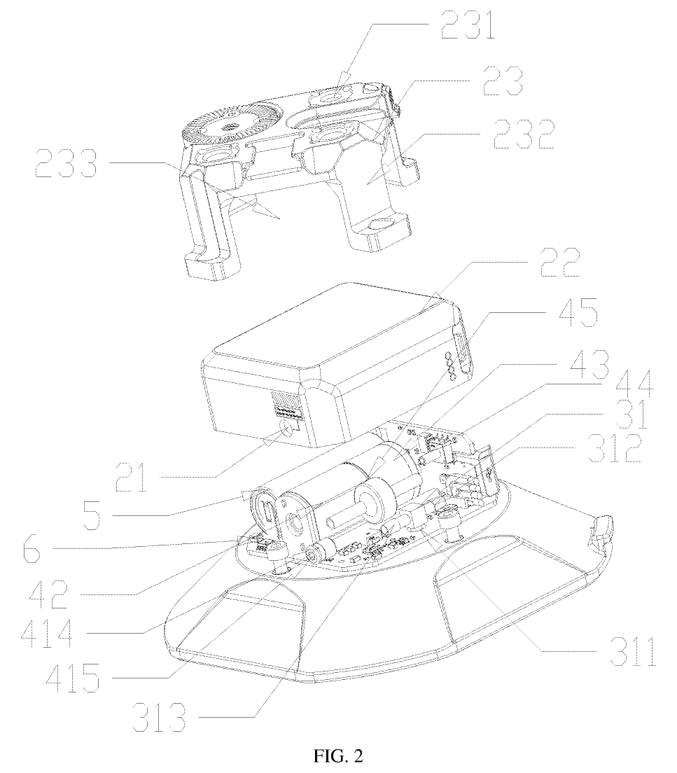

Referring to FIG. 2. in some aspects, the control assembly 4 includes a control pump 42 and a pump housing 43 connected to each other. The pump housing 43 has a first port 431 and a second port 432. The first port 431 is connected to the end of the connection assembly 3 distal from the adsorption cavity 11. The second port 432 can be connected to the first discharge tube 41. After the control pump 42 is activated, it begins evacuating air. Under the pressure difference, air from the adsorption cavity 11 of the suction cup 1 rapidly enters the pump housing 43, enabling the suction cup 1 to establish adhesion quickly. Meanwhile, air within the pump housing 43 is discharged out of the housing assembly 2 through the second port 432 via the first discharge tube 41.

In some aspects, referring to FIG. 2, the first discharge tube 41 includes a first conduit 412 and a connector 413. The connector 413 is disposed within the opening 21. The first conduit 412 can be connected to the control assembly 4, and the open end 411 can be connected to the connector 413. The connector 413 can be stably installed in the opening 21. In some aspects, the wall of the opening 21 can be clamped within a clamping groove 414 on the outer wall of the connector 413 for stable installation. In some aspects, the connector 413 includes a mounting hole 415, and the open end 411 of the first conduit 412 can be inserted into the mounting hole 415. When the control pump 42 operates, air from the adsorption cavity 11 of the suction cup 1 flows along the connection assembly 3 into the pump housing 43, allowing the suction cup 1 to reach a safe negative pressure, which facilitates adhesion. Air within the pump housing 43 is discharged out of the housing assembly 2 through the second port 432 via the open end 411 of the first conduit 412. With this configuration, even if the operating environment is damp during the operation of the suction cup 1, moisture can be discharged out of the housing along with the airflow, thereby providing moisture-proof protection for the structure and components inside the housing assembly 2.

In some aspects, the connector 413 is an elastic connector made of an elastic material such as rubber, which is pressed into the opening 21 so that the wall of the opening 21 engages with the clamping groove 414. The first conduit 412 is a flexible tube, which facilitates an interference fit within the mounting hole 415, enhancing sealing. The use of a flexible tube enables the first conduit 412 to conform to the shape of the space within the housing assembly 2 and to be bent relatively easily.

In some aspects, the control assembly 4 further includes a detection module 44 and a check valve 45. The connection assembly 3 includes a three-way connector 31. The three-way connector 31 includes a third port 311, a fourth port 312, and a fifth port 313. The third port 311 is in fluid communication with the adsorption cavity 11 of the suction cup 1. The fourth port 312 is in fluid communication with the detection module 44. The check valve 45 is disposed between the fifth port 313 and the first port 431 of the pump housing 43 to allow unidirectional airflow from the fifth port 313 to the pump housing 43. During operation, upon activation of the control pump 42, the detection module 44 begins detection. When a preset value is detected, indicating that the suction cup 1 has reached a safe operating range (e.g., vacuum range, negative pressure range), the control pump 42 is turned off. When the detection module 44 detects that the vacuum pressure of the suction cup 1 is below a threshold value, it controls the suction cup 1 to resume operation. In this embodiment, the preset value and the threshold value may be determined through repeated testing. The range between the threshold value and the preset value constitutes the safe negative pressure range of the suction cup. In some aspects, a limiting member 24 is disposed within the housing assembly 2. The limiting member has a limiting space 241, and the three-way connector 31 is accommodated within the limiting space 241. Each port of the three-way connector 31 is retained within the limiting space 241. In some aspects, the detection module 44 may be an air pressure sensor.

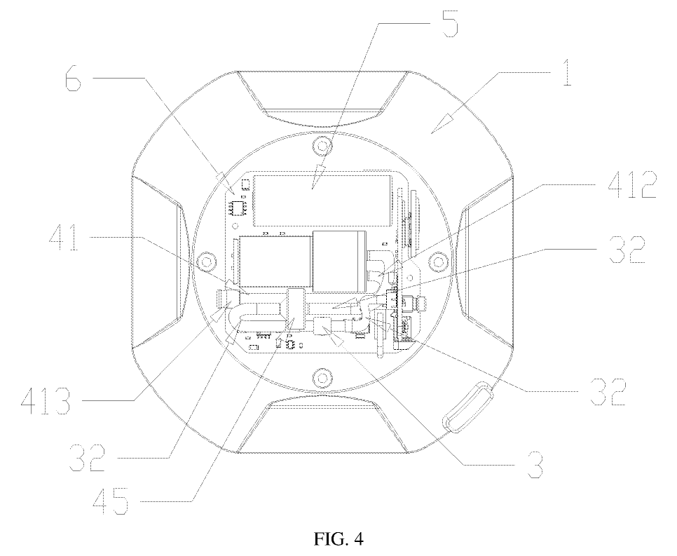

In some aspects, referring to FIG. 4, the connection assembly 3 further includes a plurality of connecting tubes 32. The fourth port 312 is connected to the detection module 44 via one of the connecting tubes 32. The fifth port 313 is connected to one end of the check valve 45 via another one of the connecting tubes 32. The other end of the check valve 45 is connected to the first port 431 of the pump housing 43 via yet another one of the connecting tubes 32. With this arrangement, multiple structural components can make full use of the spatial configuration within the housing assembly 2, and the various structural components are interconnected via the connecting tubes 32. In some aspects, the plurality of connecting tubes 32 may be flexible tubes to facilitate optimal utilization of the space within the housing assembly 2.

In some aspects, the housing assembly 2 includes a housing 22 and a connecting member 23. The connecting member 23 is detachably connected to the suction cup 1 so as to form a receiving cavity for accommodating the housing 22. The side of the connecting member 23 facing away from the suction cup 1 is provided with at least one connection interface 231 for connecting to external accessories. This configuration enables the suction cup assembly 10 described herein to be integrated into the ecosystem of various photographic accessories. For example, it can be adapted for use with a vehicle-mounted shock-absorbing arm, enabling secure attachment of the arm onto a vehicle.

In some aspects, the connecting member 23 includes four support arms 232. The four support arms 232 can be connected to the suction cup 1 by screws, thereby forming a receiving cavity 233 between the connecting member 23 and the side of the suction cup 1 opposite the adsorption cavity 11. The housing 22 can be installed within the receiving cavity 233, and various components such as electronic components can be mounted inside the housing 22, thereby giving the entire suction cup 1 a modular design, which facilitates production and installation.

In some aspects, the connection port is provided on the surface of the connecting member 23 facing away from the suction cup 1. The connection interface 231 includes at least one of a gear ring, a threaded interface, a standardized quick-release mounting system (e.g., NATO mount), a cold shoe interface, an Arca-type sliding groove, or a Manfrotto sliding groove. Users can connect the suction cup assembly 10 to different photographic accessories via different interfaces, thereby enabling the installation of photographic accessories at the adsorption position or surface. For example, action camera accessories can be mounted onto the suction cup 1 via the connection structure.

In some aspects, the connection interface 231 is movably connected to the side of the connecting member 23 facing away from the suction cup 1 via a pivot shaft. The connection interface 231 includes one of a tube clamp, a Mitchell mount, or a quick-release mount. The quick-release mount may be any commercially available quick-release mount, which will not be discussed in detail herein.

In some aspects, referring to FIGS. 2-4, the suction cup assembly 10 includes a power source 5 and a circuit board 6. Both the control assembly 4 and the power source 5 are disposed on the circuit board 6. The power source 5 is configured to supply power to the control assembly 4 and the circuit board 6.

As used in the claims, the indefinite articles "a" and "an" should be understood to mean "one or more" unless explicitly stated otherwise or unless the context clearly dictates a singular interpretation. The use of these articles does not limit the claimed invention to a single instance of the referenced element but rather encompasses multiple instances where applicable.

Although the invention has been described with reference to specific exemplary embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention is not limited to the particular embodiments disclosed, but that the invention includes all embodiments falling within the scope of the appended claims and their legal equivalents.

What is claimed is:

1. A suction cup assembly, comprising:
a suction cup configured with an adsorption cavity;
a housing assembly detachably connected to the suction cup and configured with an opening;
a connection assembly provided within the housing assembly and in fluid communication with the adsorption cavity;
a control assembly disposed within the housing assembly, connected to an end of the connection assembly distal from the adsorption cavity; and
a first discharge tube, wherein an open end of the first discharge tube is accommodated in the opening.

2. The suction cup assembly according to claim 1, wherein the control assembly comprises a control pump and a pump housing connected to each other; and
wherein the pump housing is configured with a first port and a second port, the first port is connected to the end of the connection assembly distal from the adsorption cavity, and the second port is connected to the first discharge tube.

3. The suction cup assembly according to claim 1, wherein the first discharge tube comprises a first conduit and a connector; and
wherein the connector is provided in the opening, the first conduit is connected to the control assembly, and an open end of the first conduit is connected to the connector.

4. The suction cup assembly according to claim 3, wherein the connector comprises a mounting hole; and
wherein an exterior of the connector is configured with a clamping groove, a wall of the opening is clamped in the clamping groove, and the open end of the first conduit is configured to insert into the mounting hole.

5. The suction cup assembly according to claim 4, wherein the connector is configured as an elastic connector, configured for the wall of the opening to be clamped in the clamping groove; and
wherein the first conduit is a hose, configured to be inserted into the mounting hole.

6. The suction cup assembly according to claim 2, wherein the control assembly further comprises a detection module and a check valve;
wherein the connection assembly comprises a three-way connector, the three-way connector comprises a third port, a fourth port, and a fifth port, and the third port is configured to be in fluid communication with the adsorption cavity of the suction cup; and
wherein the fourth port is configured to be in fluid communication with the detection module, and the check valve is disposed between the fifth port and the first port of the pump housing, enabling air from the fifth port to flow unidirectionally towards the pump housing.

7. The suction cup assembly according to claim 6, wherein the connection assembly further comprises multiple connecting tubes; and
wherein the fourth port is connected to the detection module via a first one of the connecting tubes, the fifth port is connected to one end of the check valve via a second one of the connecting tubes, and another end of the check valve is connected to the first port of the pump housing via a third one of the connecting tubes.

8. The suction cup assembly according to claim 7, wherein the fourth port is connected to the detection module, the detection module being configured to deactivate the control pump in response to detecting a vacuum pressure reaching a preset value, and to activate the control pump in response to detecting the vacuum pressure below a threshold; and
wherein a range between the threshold and the preset value defines a suction cup safety range for the vacuum pressure.

9. The suction cup assembly according to claim 1, wherein the housing assembly comprises a housing and a connecting member;
wherein the connecting member is detachably connected to the suction cup to form a receiving cavity for receiving the housing; and
wherein a side of the connecting member facing away from the suction cup is provided with at least one connection interface for connecting an external accessory.

10. The suction cup assembly according to claim 9, wherein the connection interface is provided on a surface of the connecting member facing away from the suction cup; and
wherein the connection interface comprises at least one of a gear ring, a threaded interface, a NATO mount, a cold shoe interface, an Arca-type rail, an Arca-type quick release plate, a Manfrotto-type rail, or a Manfrotto-type quick release plate.

11. The suction cup assembly according to claim 9, wherein the connection interface is movably connected to the side of the connecting member facing away from the suction cup; and
wherein the connection interface comprises at least one of a clamp, a Mitchell mount, or a quick release mount.

12. The suction cup assembly according to claim 1, further comprising a limiting member disposed inside the housing assembly,
wherein the limiting member has a limiting space, and
wherein the connection assembly is confined within the limiting space.
